(19) United States
(12) Patent Application Publication
(10) Pub. No.: US 2026/0017044 A1
(43) Pub. Date: Jan. 15, 2026

(54) PLATFORM FOR MULTI-REGION CODE DEPLOYMENT OF CUSTOMIZED WORKFLOWS

(71) Applicant: DevRev, Inc., Palo Alto, CA (US)

(72) Inventors: Kapil Garg, Bengaluru (IN); Umang Malik, Ghaziabad (IN); Abhishek Bansal, Mandi Dabwali (IN); Harpinder Singh, Bengaluru (IN); Altaf Ahmad, Bengaluru (IN); Peter Marinšek, Ljubljana (SI); Luka Košenina, Ljubljana (SI)

(73) Assignee: DevRev, Inc., Palo Alto, CA (US)

(21) Appl. No.: 18/769,318

(22) Filed: Jul. 10, 2024

(51) Int. Cl. G06F 8/65

(52) U.S. Cl. CPC G06F 8/65

(57) ABSTRACT

Disclosed is a multi-region business process infrastructure system. The system includes a user interface that is configured to receive components from a user to package a business process infrastructure container. The business process infrastructure container is configured to perform a desired operation for the user. The components of the business process infrastructure container include a manifest file and a business process infrastructure code. Business process infrastructure code has computer-readable instructions that are configured to trigger the user-desired operation via the business process infrastructure container and the manifest file. The system further includes a platform that is configured to develop and deploy the business process infrastructure code to create one or more business process infrastructure modules for the business process infrastructure container to perform the desired operation.

### FIELD OF INVENTION

Embodiments of the present disclosure pertain to business process management and execution, and more particularly, to a system designed to deploy and execute, business processes across multiple regions to form the business process infrastructure.

### BACKGROUND

In the modern global marketplace, businesses often operate across multiple regions, each with unique operational needs and regulatory requirements. Managing business processes in such a geographically dispersed environment presents significant challenges in terms of maintaining consistency, scalability, and flexibility. Traditional business process management systems frequently fall short of addressing these diverse needs while preserving a cohesive operational framework.

Current systems often depend heavily on manual processes for deploying and updating business process modules across different regions. This manual intervention may lead to inefficiencies, increased error rates, and difficulty in maintaining synchronized operations across regions. Integrating new or updated business processes into a multi-region infrastructure can often be complex, time-consuming, and susceptible to errors.

There is a need for an advanced solution that simplifies the packaging, customization, deployment, and management of business processes and/or process modules. There is a requirement to enable automated instantiation and updating of such modules across various regions and organizations, to address existing efficiency and operational issues.

### SUMMARY

The following description is illustrative only and is not intended to be in any way limiting. In addition to the illustrative aspects, example embodiments, and features described, further aspects, example embodiments, and features will become apparent by reference to the drawings and the following detailed description.

Briefly, according to an example embodiment, a multi-region business process infrastructure system is provided. The system includes a user interface that is configured to receive components from a user to package a business process infrastructure container. The business process infrastructure container is configured to perform a desired operation for the user. The components of the business process infrastructure container include a manifest file and a business process infrastructure code. Business process infrastructure code has computer-readable instructions that are configured to trigger the user-desired operation via the business process infrastructure container and the manifest file. The system further includes a platform that is configured to develop and deploy the business process infrastructure code to create one or more business process infrastructure modules for the business process infrastructure container to perform the desired operation.

According to another example embodiment, a multi-region business process infrastructure system is provided. The system includes a memory storing one or more processor-executable routines and a processor communicatively coupled to the memory. The processor is configured to execute one or more processor-executable routines to receive a YAML file and a business process infrastructure code having computer-readable instructions from a user to package a business process infrastructure container. The business process infrastructure container is configured to perform a desired operation for a region and/or an organization. The processor is further configured to develop and deploy the business process infrastructure code to create one or more business process infrastructure modules for the business process infrastructure container to perform the desired operation for the region and/or an organization. The processor is further configured to facilitate the deployment of one or more business process infrastructure modules for a plurality of regions and/or organizations.

According to another example embodiment, a method for implementing a business process for a plurality of regions for a client is disclosed. The method includes receiving a YAML file and a business process infrastructure code with computer-readable instructions from a user to package a business process infrastructure container to perform a desired operation for a region and/or an organization. The method further includes deploying the business process infrastructure code to create one or more business process infrastructure modules for the business process infrastructure container to perform the desired operation for the region and/or an organization. The method further includes distributing one or more business process infrastructure modules to a plurality of regions and/or organizations.

### BRIEF DESCRIPTION OF THE DRAWINGS

The disclosure will be described and explained with additional specificity and detail with the accompanying figures in which:

FIG. 1 is a block diagram illustrating components of a multi-region business process infrastructure system, according to some aspects of the present description;

FIG. 2 is a block diagram that illustrates components of the multi-region business process infrastructure system of FIG. 1, according to some aspects of the present description;

FIG. 3 illustrates an example process flow for developing one or more business process infrastructure containers using a business process infrastructure platform of FIG. 1;

FIG. 4 illustrates an example process flow for publishing one or more business process infrastructure modules for distribution across multiple regions and/or organizations using the platform of FIG. 1;

FIG. 5 illustrates an example process flow for auto-upgradation of one or more business process infrastructure containers within the platform of FIG. 1 for multiple regions and/or organizations;

FIG. 6 illustrates a flow chart of the process of implementation of one or more business process infrastructure containers for a plurality of regions; and

FIG. 7 is a block diagram of an embodiment of a computing device in which the multi-region business process infrastructure system, described herein, is implemented.

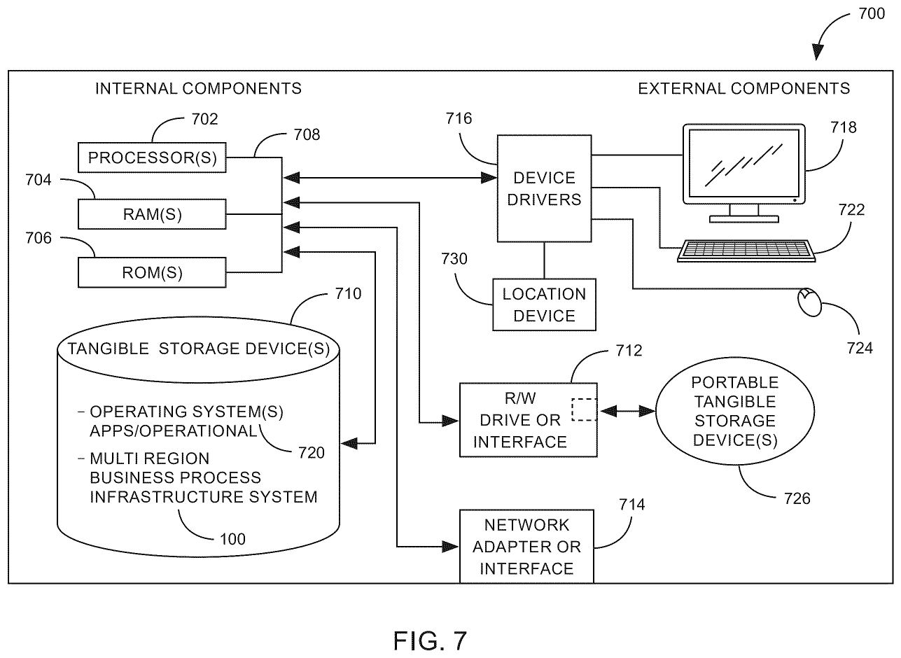

### DETAILED DESCRIPTION

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein. On the contrary, example embodiments are to cover all modifications, equivalents, and alternatives thereof.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Before discussing example embodiments in more detail, it is noted that some example embodiments are described as processes or methods depicted as flowcharts. Although the flowcharts describe the operations as sequential processes, many of the operations may be performed in parallel, concurrently, or simultaneously. In addition, the order of operations may be re-arranged. The processes may be terminated when their operations are completed but may also have additional steps not included in the figures. It should also be noted that in some alternative implementations, the functions/acts/steps noted may occur out of the order noted in the figures. For example, two figures shown in succession may be executed substantially concurrently or may sometimes be executed in the reverse order, depending upon the functionality/acts involved.

Further, although the terms first, second, etc. may be used herein to describe various elements, components, regions, layers, and/or sections, it should be understood that these elements, components, regions, layers, and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the scope of example embodiments.

Spatial and functional relationships between elements (for example, between modules) are described using various terms, including “connected,” “engaged,” “interfaced,” and “coupled.” Unless explicitly described as being “direct,” when a relationship between the first and second elements is described in the description below, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting. Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless specifically stated otherwise, or as is apparent from the description, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

This section will describe an illustrative architecture for a multi-region business process infrastructure system.

Embodiments of the invention provide a multi-region business process infrastructure system designed to facilitate the packaging, deployment, and distribution of business process components across various regions. These embodiments address significant challenges faced by conventional business process management systems, such as the complexity of managing numerous software components across different regions and the lack of standardized methods for packaging and distribution of infrastructure on a global scale. The embodiments of the invention enable creation of multi-region business process infrastructure modules that include a manifest file and computer-readable instructions to trigger user-desired operations for organizations in multiple regions. This allows users to easily package, customize, deploy, and manage their business process infrastructure across multiple regions and organizations, enhancing overall efficiency, scalability, and reusability across different geographic locations.

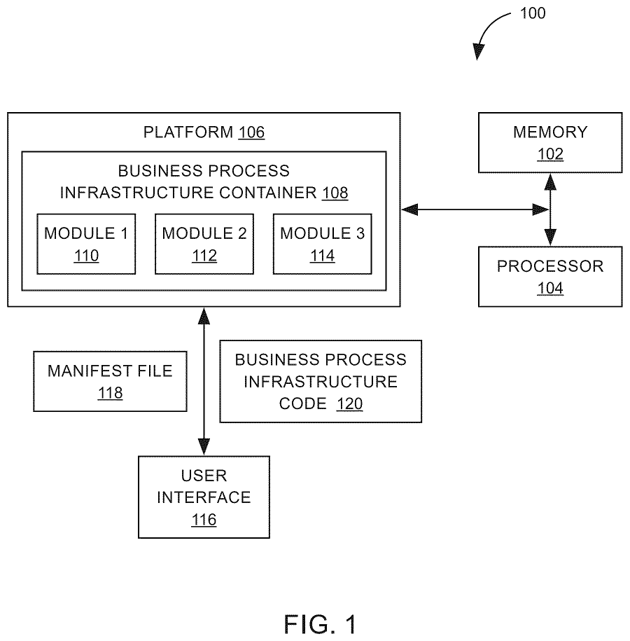

FIG. 1 is a block diagram 100 illustrating components of a multi-region business process infrastructure system to implement some embodiments of the invention. The components include a memory 102, a processor 104, a platform 106, and a user interface 116. The memory 102 is configured to store one or more processor-executable routines and the processor 104 is communicatively coupled to the memory 102 to execute the one or more processor-executable routines to enable operation of the platform 106. The user interface 116 is configured to receive components such as a manifest file 118 and a business process infrastructure code 120 from a user to package a business process infrastructure container such as generally represented by reference numeral 108. In the example embodiment, the business process infrastructure container 108 comprises one or more business process infrastructure modules, such as represented by reference numerals 110, 112, and 114. The business process infrastructure 108 is configured to perform a desired operation for the user.

The multi-region business process infrastructure system 100 is configured to receive user inputs related to the desired operations to be performed on the platform 106 via the user interface 116. The business process infrastructure modules 110, 112, and 114, may be selected and configured based on the user inputs and may be packaged as the business process infrastructure container 108. Each of these business process infrastructure modules 110, 112, and 114 is configured to perform a specific operation for the business process. Examples of business process infrastructure modules such as 110 include automation modules, commands, dashboards, webhooks, datasets, AI agents, interactivity components for user interface, custom objects, or combinations thereof.

The components of the business process infrastructure container 108 include the manifest file 118 that has details of the one or more business process infrastructure modules 110, 112 and 114. In addition, the components for the business process infrastructure container 108 also include the business process infrastructure code 120 having computer-readable instructions configured to trigger the user-desired operation via the one or more business process infrastructure modules 110, 112, and 114 and the manifest file 118. In operation, the platform 106 is configured to develop and deploy the business process infrastructure code 120 to create the one or more business process infrastructure modules 110, 112, and 114 for the business process infrastructure container 108 to perform the desired operation.

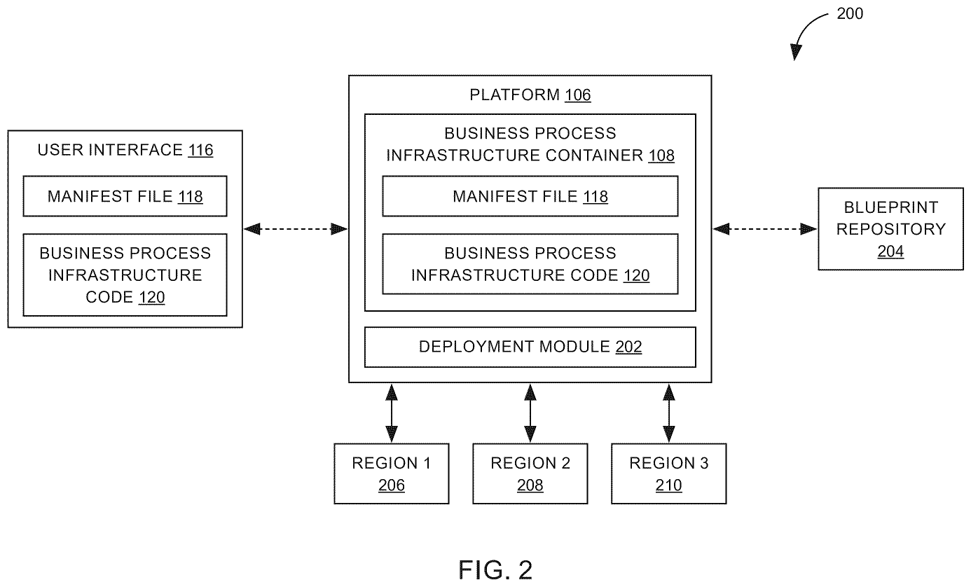

The multi-region business process infrastructure system 100 is configured to select the one or more business process infrastructure modules 110, 112, and 114 and package the selected business process infrastructure modules with the manifest file 118 in the business process infrastructure container 108 based on the user inputs. The multi-region business process infrastructure system 100 is further described with reference to FIG. 2.

FIG. 2 illustrates components 200 of the multi-region business process infrastructure system 100 of FIG. 1. The system 200 comprises the user interface 116 and the platform 106. The user interface 116 is configured to receive components from the users to package the business process infrastructure container 108, to perform one or more desired operations. These components include the manifest file 118 and the business process infrastructure code 120. Moreover, the platform 106 is configured to develop and deploy the business process infrastructure code 120 to create the business process infrastructure modules 110, 112, and 114 that execute the desired operations.

As illustrated, the platform 106 further includes a business process infrastructure container 108 and a deployment module 202. In this embodiment, the business process infrastructure container 108 comprises the manifest file 118 and the business process infrastructure code 120. The business process infrastructure container 108 is configured to facilitate the execution of user-desired operations. This business process infrastructure container 108 leverages a modular architecture, and allows users to select and configure specific business process infrastructure modules 110 to meet their operational needs. In this embodiment, the manifest file 118 includes details of the business process infrastructure modules 110. Moreover, the business process infrastructure code 120 with computer-readable instructions is configured to trigger the user-desired operation via the one or more business process infrastructure modules 110 and the manifest file 118.

The platform 106 is configured to provide user access to a wide range of business process infrastructure modules 110. In this embodiment, platform 106 offers a user-friendly interface to access the plurality of the business process infrastructure modules 110 that are available for deployment for an organization. Each of these business process infrastructure modules 110 serves a specific purpose and may be combined with other business process infrastructure modules to create a tailored solution for the user. As previously described, the business process infrastructure modules 110 may include, but are not limited to, automation tools, commands, dashboards, webhooks, datasets, AI agents, interactivity components for user interface, custom objects and the combination thereof and are configured to provide a versatile and configurable business infrastructure for an organization.

Moreover, the manifest file 118 includes detailed information about the business process infrastructure modules 110. In this example, the manifest file 118 is a YAML (YAML Ain′t Markup Language) file and includes module details such as name, description, access permissions, or combinations thereof. The YAML file 118 further includes detailed information about the connections between the one or more business process infrastructure modules 110 that facilitate the integration of the modules. The YAML file 118 includes configurable inputs that enable the deployment of the business process infrastructure container 108 on a new platform by adjusting the necessary parameters.

The business process infrastructure code 120 with computer-readable instructions is configured to trigger the user-desired operations by leveraging the information in the manifest file 118 and the capabilities of the business process infrastructure module 110. The system 100 supports receiving these instructions through programming languages such as Typescript or JavaScript, providing flexibility and ease of integration with various platforms.

The platform 106 is further configured to facilitate the instantiation of the one or more business process infrastructure modules 110 for an individual organization via the deployment module 202. The deployment module 202 utilizes the business process infrastructure code 120 and the corresponding manifest file 118 to instantiate the business process infrastructure module 110 for the organization. The deployment module 202 is configured to manage the deployment of the business process infrastructure code 120 across various regions and/or organizations. The deployment module 202 facilitates the process of instantiation and deployment of the selected business process infrastructure modules 110 in desired locations, providing seamless integration and functionality across different environments.

In operation, the platform 106 is further configured to publish the one or more business process infrastructure modules 110, 112, 114 for distribution over the platform 106. Once the business process infrastructure modules 110, 112, 114 are published, the deployment module 202 leverages the platform to facilitate their instantiation in the respective regions. This involves creating a blueprint for each of the business process infrastructure modules 110, 112, 114. The blueprint typically includes comprehensive information required for deployment of the business process infrastructure modules 110, 112, 114 in other regions and organizations. Such blueprints are stored in a centralized blueprint repository 204, that ensures easy access and management for a plurality of users.

In some examples, the blueprint repository 204 may be implemented as a component of the business process infrastructure platform 106. The stored blueprints may be accessed and used for instantiation of the one or more business process infrastructure modules 110, 112, 114 in new regions such as represented by reference numerals 206, 208 and 210. Once the user from another region and/or organization requests instantiation, the platform 106 retrieves the appropriate blueprints from the blueprint repository 204 and transmits them to the requesting region and/or organization, 206, 208, and 210. It should be noted that each of the regions 206, 208 and 210 may have additional infrastructure components to facilitate the instantiation process based upon initiation by an end user of the respective region. Such components may communicate with the platform 106 to access the blueprints and facilitate the deployment process.

The deployment module 202 of the platform 106 is configured to deploy the business process infrastructure code 120, ensuring that the business process infrastructure modules 110, 112, 114 are appropriately instantiated and operational in the new environment. Additionally, the platform 106 is equipped to create the necessary business process infrastructure modules 110 tailored to the specific needs of the new region or organization, ensuring seamless integration and functionality.

In another embodiment, the platform 106 is configured to support automatic versioning updates for the business infrastructure code 120 across regions. In particular, the platform 106 is configured to receive an updated version of the business infrastructure code 120 from the user. The platform 106 automatically initiates deployment of the updated code within the relevant region and/or organization. Concurrently, the platform 106 generates updated blueprints that reflect the latest configuration and functionalities of each of the business process infrastructure modules 110. These updated blueprints are securely stored in the blueprint repository 204, ensuring that the system maintains a comprehensive record of all module versions.

In certain embodiments, the platform 106 is configured to support automatic updates for the manifest file 118 across regions. In particular, the platform 106 is configured to receive an updated version of the manifest file 120 from the user and to update blueprint of each of the one or more business process infrastructure modules 110 corresponding to the updated manifest file. Further the platform 106 is configured to propagate the corresponding changes to the one or more business process infrastructure modules 110 across other regions and/or organizations.

Furthermore, the platform 106 is also configured to notify users across the regions and/or organizations such as 206, 208, and 210 corresponding to the updates to respective business process infrastructure modules 110. Upon completing the deployment of the updated business process infrastructure code 120, the platform 106 transmits notifications to inform users of the update. Additionally, it transmits updated blueprints to facilitate seamless integration and functionality of the updated business process infrastructure modules 110 in the respective regions and/or organizations 206, 208, and 210.

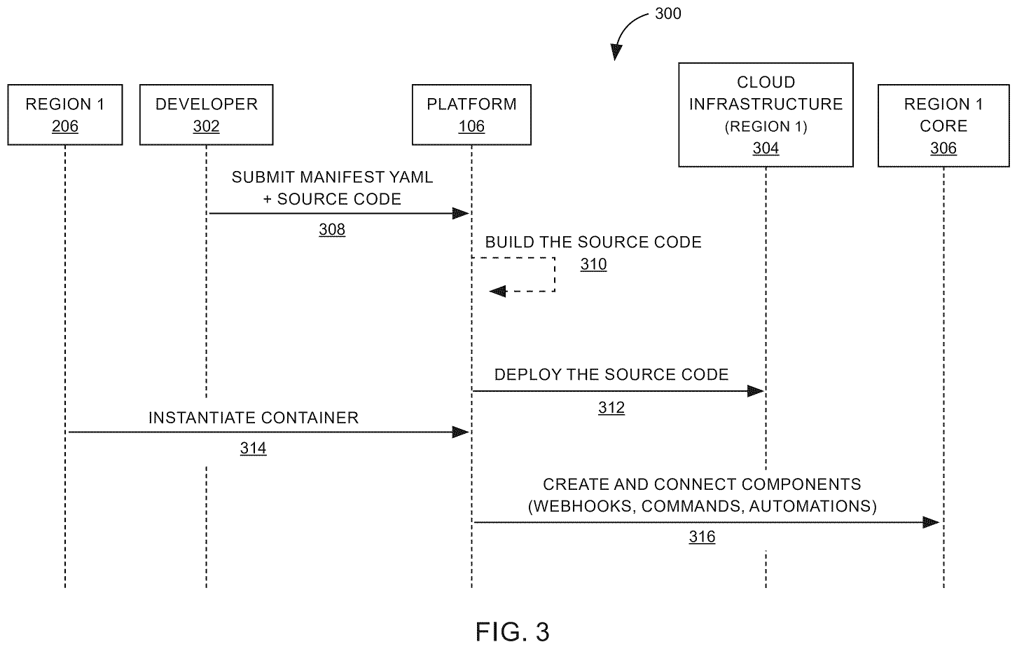

FIG. 3 illustrates an embodiment of an example process flow 300 for developing one or more business process infrastructure containers by developers using a business process infrastructure platform, such as the platform 106 of FIG. 1. In this example, the platform 106 provides access to developers 302 to create and develop the business process infrastructure container 108 by submitting the manifest file 118 and the business process infrastructure code 120, as represented by reference numeral 308.

The platform 106 is configured to build the provided business process infrastructure code 120, as shown in block 310. The received manifest file 118 and the business process infrastructure code 120 are packaged into the business process infrastructure container 108 that is designed to perform a specific operation for a region or organization. At block 312, the platform 106 deploys the packaged business process infrastructure code 120 in the cloud infrastructure 304 of a specified region and/or organization to create the one or more business process infrastructure modules 110. For instance, platform 106 may deploy the business process infrastructure code 120 in the cloud infrastructure 304 of region 206.

In operation, the user of the region 206 initiates the instantiation of the business process infrastructure container 108 (block 314) corresponding to the desired operations to be performed. The users of region 206 provide configuration values for the business process infrastructure container 108 to the platform 106. These configuration values may include the business process infrastructure modules 110 selection (e.g., dashboards, automation, workflows, webhooks, datasets, AI agents, interactivity components for user interface, custom objects), access permissions for different users or roles, connection details for external systems or databases, parameter values for configurable settings, user interface customizations, automation rules, data sources, security settings, notification preferences, performance settings, compliance settings, and localization details, among others. For instance, the region 206 may select the business process infrastructure modules 110 such as webhooks, commands, and automation for the business process infrastructure container 108.

Once the user of the region 206 has provided the configuration values/settings, the platform 106 proceeds to create and connect the selected business process infrastructure module 110 based on the templated modules and configured values (block 316). Upon completion of the instantiation process, the packaged business process infrastructure container 108 is ready for deployment in the core region 306, ensuring it is tailored to the specified requirements and operational needs of the organization. This ensures that the business process infrastructure container is configured accurately and efficiently to meet the demands of the target region or organization.

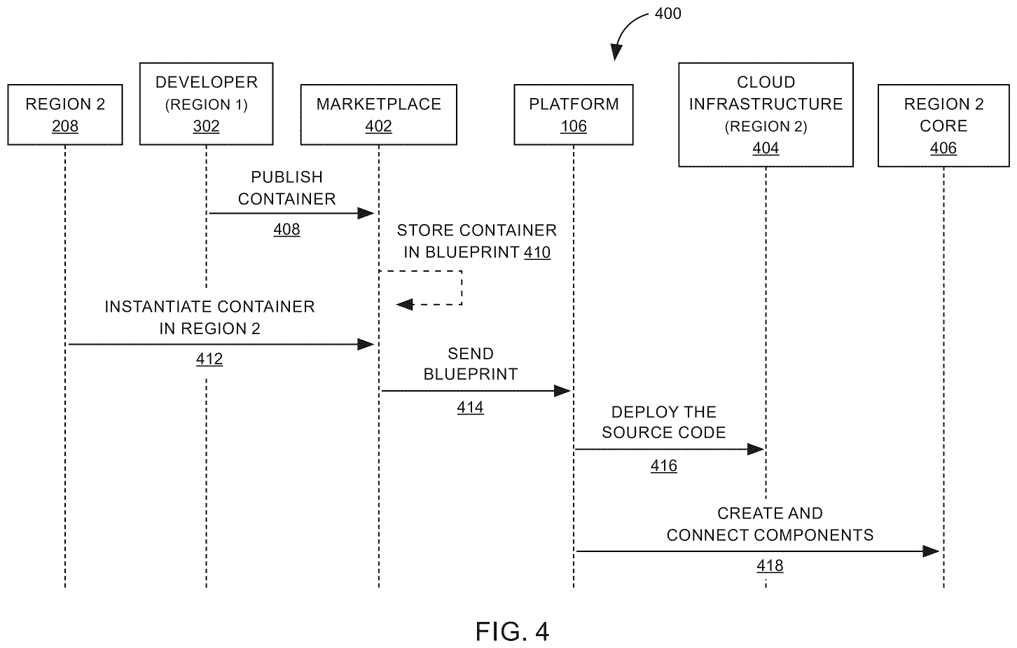

FIG. 4 illustrates an embodiment of an example process flow 400 for publishing the one or more business process infrastructure modules 110 for distribution across multiple regions and/or organizations via the platform, such as the platform 106 of FIG. 1. In this example, the platform 106 provides access to developers in region 1 (302) to publish the business process infrastructure container 108 in various marketplaces 402 for distribution on the platform 106, as represented by reference numeral 408. For instance, marketplaces may include the business process infrastructure containers 108 such as smart import KB, Slash commands, Jira, Auto routing, Good meetings, Automatic customer reply, Zendesk, Salesforce, and GitHub.

Once the business process infrastructure containers 108 are published in marketplace 402, they are stored as a blueprint (block 410). Each blueprint contains comprehensive deployment information necessary for other regions and organizations. These blueprints are then stored in the centralized blueprint repository 204.

In this example, the user of region 208 initiates the instantiation of the business process infrastructure container 108 (block 412) corresponding to the desired operations to be performed. The platform 106 retrieves the appropriate blueprints from the blueprint repository 204 and transmits them to the requesting region and/or organization, as represented by reference numeral 414.

The platform 106 then deploys the business process infrastructure code 120 in the cloud infrastructure 404 of region 2 (block 416), ensuring that the business process infrastructure modules 110 are instantiated and operational in the new environment. After deploying the business process infrastructure module 110, the platform 106 proceeds to create and connect the deployed components to the core region 406. As described before, the core region 406 may include additional infrastructure components to facilitate the deployment based upon initiation by an end user of the respective region. Such components may communicate with the platform 106 to access the blueprints and facilitate the deployment process. This enables seamless distribution and deployment of the business process infrastructure modules 110 across multiple regions and/or organizations.

It should be noted that the business process infrastructure code 120 deployment (416) is implemented upon initiation of the instantiation of the business process infrastructure container 108 (block 412) for a first instance. For subsequent implementations, once the business process infrastructure code 120 is deployed in the region, this step (block 416) may be skipped.

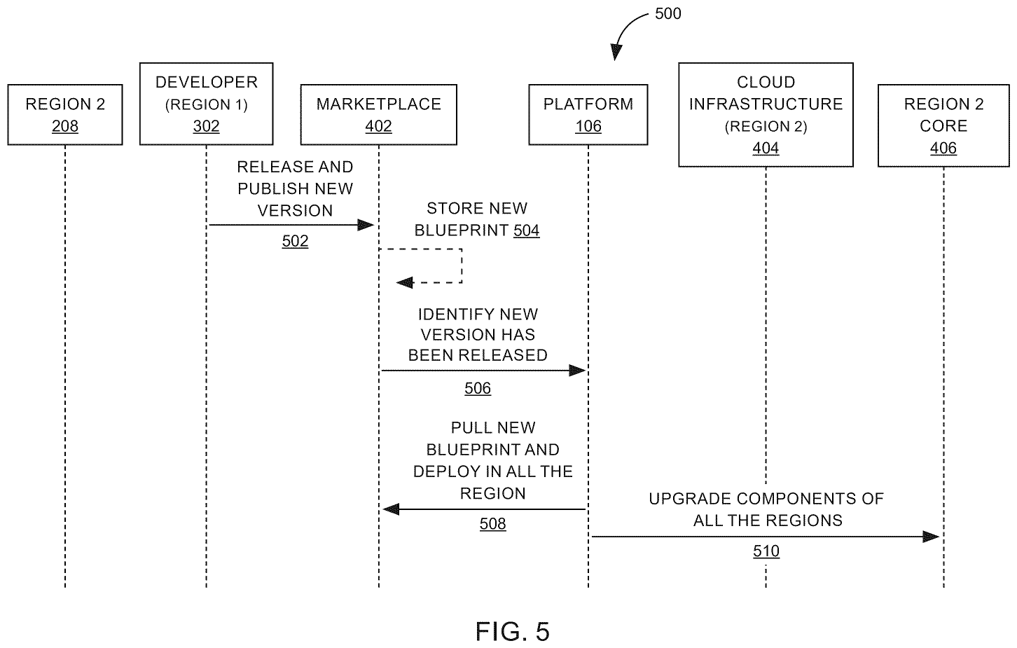

FIG. 5 illustrates an embodiment of an example process flow 500 for auto-upgradation of one or more business process infrastructure containers within a platform in all the regions and/or organizations, such as platform 106 of FIG. 1. In this example, platform 106 is configured to provide access to the developers in region 302 to release and publish the updated version of business process infrastructure container 108 in various marketplaces 402 for distribution on the platform 106, as represented by reference numeral 502. Once the updated version of business process infrastructure containers 108 is published in marketplace 402, they are automatically stored as a new blueprint (block 504). These new blueprints are then stored in the centralized blueprint repository 204.

The platform 106 is configured to identify the new version of the business process infrastructure container 108 that has been released (block 506). Once the new version is published on the platform 106, platform transmits the new blueprints and deploys them to the requesting region and/or organization (block 508). In this example, the requesting region and/or organization is region 208. The platform 106 is configured to automatically upgrade components across all the regions and/or organizations. This ensures that regions and/or organizations always have access to the latest features and improvements without manual intervention, maintaining the efficiency and effectiveness of their business processes.

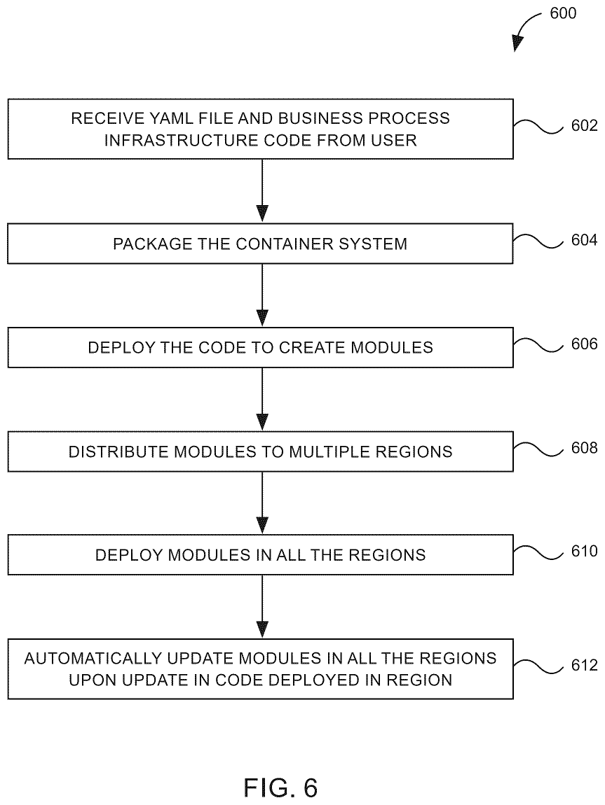

FIG. 6 is a flowchart illustrating an example process 600 of implementation of one or more business process infrastructure containers 108 for a plurality of regions using the platform 106. At block 602, the YAML file and the business process infrastructure code containing computer-readable instructions are received from a user. The YAML file includes detailed configurations necessary for the business process infrastructure, and the business process infrastructure code comprises computer-readable instructions required to perform the desired operations for a specific region and/or organization. The received YAML file and the business process infrastructure code are packaged into the business process infrastructure container, that is designed to perform a specific operation for a region or organization (block 604). This containerization step is critical as it prepares the infrastructure components for deployment by encapsulating the configurations and instructions into a deployable format.

This business process infrastructure container includes the selected business process infrastructure modules, along with the computer-readable instructions necessary to trigger the desired operation on the client platform. Additionally, it includes a corresponding manifest file, typically in YAML format, that provides detailed information about the selected business process infrastructure modules. The manifest file may include the names, descriptions, access permissions, interconnections, and configurable inputs for deployment on the platform, ensuring that the business process infrastructure modules are configured and integrated to execute the desired tasks effectively.

At block 606, the packaged business process infrastructure code is deployed to create the one or more business process infrastructure modules. These modules are configured to execute the desired operations as specified by the user for the target region and/or organization. Once the modules are created, the method includes distributing these business process infrastructure modules to a plurality of regions and/or organizations (block 608). This distribution ensures that the necessary infrastructure is available in various operational environments, facilitating widespread implementation of the business process.

At block 610, the business process infrastructure modules are deployed in all the designated regions and/or organizations. This step ensures that each region has the required infrastructure to perform the desired operations effectively, thereby enabling consistent execution of business processes across different regions. The method further includes an automatic update mechanism. Once an update in the business process infrastructure code deployed in any region is detected, the system automatically updates the corresponding business process infrastructure modules in all the regions and/or organizations (block 612). This automatic updating process ensures that all regions are synchronized and operate with the latest version of the business process infrastructure code, thereby maintaining consistency and operational efficiency across the entire system.

The multi-region business process infrastructure system described herein provides a robust framework for the implementation and management of business processes across multiple regions, ensuring scalability, consistency, and ease of updates.

The business process infrastructure modules of the multi-region business process infrastructure system 100 described herein, are implemented in computing devices. One example of a computing device (800) is described below in FIG. 8. The computing device (800) includes one or more processor(s) (802), one or more computer-readable RAMs (804), and one or more computer-readable ROMs (806) on one or more buses (808). Further, the computing device (800) includes a tangible storage device (810) that may be used to execute operating systems (820) and the multi-region business process infrastructure system (100). The various modules of the multi-region business process infrastructure system (100) may be stored in the tangible storage device (810). Both, the operating systems (820) and the multi-region business process infrastructure system (100) are executed by one or more processor(s) (802) via one or more respective RAMs (804) (which typically include cache memory). The execution of the operating systems (820) and/or the multi-region business process infrastructure system (100) by one or more processor(s) (802), configures the one or more processor(s) (802) as a special purpose processor configured to carry out the functionalities of the operation systems (820) and/or the business process infrastructure container (108) as described above.

Examples of tangible storage devices (810) include semiconductor storage devices such as ROM, EPROM, flash memory, or any other computer-readable tangible storage device that may store a computer program and digital information.

The computing device (800) also includes an R/W drive or interface (814) to read from and write to one or more portable computer-readable tangible storage devices (828) such as a CD-ROM, DVD, memory stick, or semiconductor storage device. Further, network adapters or interfaces (812) such as TCP/IP adapter cards, wireless Wi-Fi interface cards, or 3G or 4G wireless interface cards, or other wired or wireless communication links are also included in computing devices.

In one example embodiment, the multi-region business process infrastructure system (100) may be stored in the tangible storage device (810) and may be downloaded from an external computer via a network (for example, the Internet, a local area network, or other, wide area network) and network adapter or interface (812).

Computing device (800) further includes device drivers (816) to interface with input and output devices. The input and output devices may include a computer display monitor (818), a keyboard (822), a keypad, a touch screen, a computer mouse (824), and/or some other suitable input device.

In this description, including the definitions mentioned earlier, the term ‘module’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware. The term code, as used above, may include software, firmware, and/or microcode, and may refer to programs, routines, functions, classes, data structures, and/or objects.

Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above. Shared memory hardware encompasses a single memory device that stores some or all code from multiple modules. Group memory hardware encompasses a memory device that, in combination with other memory devices, stores some or all code from one or more modules.

In some embodiments, the module may include one or more interface circuits. In some examples, the interface circuits may include wired or wireless interfaces that are connected to a local area network (LAN), the Internet, a wide area network (WAN), or combinations thereof. The functionality of any given module of the present description may be distributed among multiple modules that are connected via interface circuits. For example, multiple modules may allow load balancing. In a further example, a server (also known as remote, or cloud) module may accomplish some functionality on behalf of a client module.

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

While only certain features of several embodiments have been illustrated, and described herein, many modifications and changes will occur to those skilled in the art. It is, therefore, to be understood that the appended claims are intended to cover all such modifications and changes as fall within the true spirit of inventive concepts.

The aforementioned description is merely illustrative in nature and is in no way intended to limit the disclosure, its application, or its uses. The broad teachings of the disclosure may be implemented in a variety of forms. Therefore, while this disclosure includes particular examples, the true scope of the disclosure should not be so limited since other modifications will become apparent upon a study of the drawings, and the specification. It should be understood that one or more steps within a method may be executed in different order (or concurrently) without altering the principles of the present disclosure. Further, although each of the example embodiments is described above as having certain features, any one or more of those features described with respect to an example embodiment of the disclosure may be implemented in and/or combined with features of any of the other embodiments, even if that combination is not explicitly described. In other words, the described example embodiments are not mutually exclusive, and permutations of one or more example embodiments with one another remain within the scope of this disclosure.

The example embodiment or each example embodiment should not be understood as a limiting/restrictive of inventive concepts. Rather, numerous variations and modifications are possible in the context of the present disclosure, in particular those variants and combinations which may be inferred by the person skilled in the art with regard to achieving the object for example by combination or modification of individual features or elements or method steps that are described in connection with the general or specific part of the description and/or the drawings, and, by way of combinable features, lead to a new subject matter or to new method steps or sequences of method steps, including insofar as they concern production, testing and operating methods. Further, elements and/or features of different example embodiments may be combined with each other and/or substituted for each other within the scope of this disclosure.

Still further, any one of the above-described and other example features of example embodiments may be embodied in the form of an apparatus, method, system, computer program, tangible computer-readable medium, and tangible computer program product. For example, the aforementioned methods may be embodied in the form of a system or device, including, but not limited to, any of the structure for performing the methodology illustrated in the drawings.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple pl that are connected via interface circuits. For example, multiple modules may allow load balancing. In a further example, a server (also known as remote, or cloud) module may accomplish some functionality on behalf of a client module.

Further, at least one example embodiment relates to a non-transitory computer-readable storage medium comprising electronically readable control information (e.g., computer-readable instructions) stored thereon, configured such that when the storage medium is used in a controller of a magnetic resonance device, at least one example embodiment of the method is carried out.

Even further, any of the aforementioned methods may be embodied in the form of a program. The program may be stored on a non-transitory computer readable medium, such that when run on a computer device (e.g., a processor), cause the computer device to perform any one of the aforementioned methods. Thus, the non-transitory, tangible computer readable medium is adapted to store information and is adapted to interact with a data processing facility or computer device to execute the program of any of the above-mentioned embodiments and/or to perform the method of any of the above-mentioned embodiments.

The computer readable medium or storage medium may be a built-in medium installed inside a computer device's main body or a removable medium arranged so that it may be separated from the computer device's main body. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include but are not limited to, rewriteable non-volatile memory devices (including, for example, flash memory devices, erasable programmable read-only memory devices, or mask read-only memory devices), volatile memory devices (including, for example, static random access memory devices or a dynamic random access memory devices), magnetic storage media (including, for example, an analog or digital magnetic tape or a hard disk drive), and optical storage media (including, for example, a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The apparatuses and methods described in this application may be partially or fully implemented by a special purpose computer created by configuring a general-purpose computer to execute one or more particular functions embodied in computer programs. The functional blocks and flowchart elements described above serve as software specifications, which may be translated into computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

We claim:

1. A multi-region business process infrastructure system, wherein the system comprises:
a user interface configured to receive components from a user to package a business process infrastructure container, wherein the business process infrastructure container is configured to perform a desired operation for the user and wherein the components comprise:
a manifest file; and
a business process infrastructure code having computer-readable instructions configured to trigger the user desired operation via business process infrastructure container the and the manifest file; and
a platform configured to develop and deploy the business process infrastructure code to create one or more business process infrastructure modules for the business process infrastructure container to perform the desired operation.

2. The multi-region business process infrastructure system of claim 1, wherein the manifest file comprises details to create the one or more business process infrastructure modules.

3. The multi-region business process infrastructure system of claim 2, wherein the manifest file comprises a YAML file.

4. The multi-region business process infrastructure system of claim 3, wherein the YAML file comprises name, description, access permissions, or combinations thereof for the one or more business process infrastructure modules.

5. The multi-region business process infrastructure system of claim 3, wherein the YAML file comprises details of inter-connections between the one or more business process infrastructure modules.

6. The multi-region business process infrastructure system of claim 1, wherein the business process infrastructure code comprises the computer-readable instructions in Typescript language, JavaScript programming language, or combinations thereof.

7. The multi-region business process infrastructure system of claim 1, wherein the one or more business process infrastructure modules comprise an automation module, commands, dashboards, webhooks, datasets, AI agents, interactivity components for user interface, custom objects, or combinations thereof.

8. The multi-region business process infrastructure system of claim 1, wherein the platform is further configured to facilitate the instantiation of the one or more business process infrastructure modules for an individual organization.

9. The multi-region business process infrastructure system of claim 8, wherein the platform is further configured to:
publish the one or more business process infrastructure modules for distribution over the platform;
create a blueprint of each of the one or more business process infrastructure modules, wherein each blueprint comprises information to deploy the respective business process infrastructure code for another region and/or organization;
store each blueprint in a blueprint repository.

10. The multi-region business process infrastructure system of claim 9, wherein the platform is configured to:
receive an instantiation request from a user from the another region and/or organization;
transmit one or more blueprints for one or more business process infrastructure modules to the another region and/or organization; and
deploy the business process infrastructure code in the another region and/or organization.

11. The multi-region business process infrastructure system of claim 10, wherein the platform is configured to create the one or more business process infrastructure modules for the another region and/or organization.

12. The multi-region business process infrastructure system of claim 7, wherein the platform is further configured to:
receive an updated version of the business process infrastructure code from a user;
deploy the updated business process infrastructure code in the region and/or organization;
create and update blueprint of each of the one or more business process infrastructure modules;
store the updated blueprints in the blueprint repository.

13. The multi-region business process infrastructure system of claim 12, wherein the platform is further configured to:
transmit an updation notification to the user from the another region and/or organization;
transmit one or more blueprints for one or more updated business process infrastructure modules to the another region and/or organization; and
deploy the updated business process infrastructure code in the another region and/or organization.

14. The multi-region business process infrastructure system of claim 13, wherein the platform is further configured to:
receive an updated version of the manifest file from a user;
update blueprint of each of the one or more business process infrastructure modules corresponding to the updated manifest file;
transmit the updated blueprints to another region and/or organization to propagate the changes to the one or more business process infrastructure modules.

15. A multi-region business process infrastructure system, wherein the system comprises:
a memory storing one or more processor-executable routines; and
a processor communicatively coupled to the memory, the processor configured to execute the one or more processor-executable routines to:
receive a YAML file and a business process infrastructure code having computer-readable instructions from a user to package a business process infrastructure container, wherein the business process infrastructure container is configured to perform a desired operation for a region and/or an organization;
develop and deploy the business process infrastructure code to create one or more business process infrastructure modules for the business process infrastructure container to perform the desired operation for the region and/or an organization; and
facilitate deployment of the one or more business process infrastructure modules for a plurality of regions and/or organizations.

16. The multi-region business process infrastructure system of claim 15, wherein the YAML file comprises name, description, access permissions, or combinations thereof for the one or more business process infrastructure modules.

17. The multi-region business process infrastructure system of claim 15, wherein the business process infrastructure code comprises the computer-readable instructions in Typescript language, JavaScript programming language, or combinations thereof.

18. The multi-region business process infrastructure system of claim 15, wherein the one or more business process infrastructure modules comprise an automation module, commands, dashboards, webhooks, datasets, AI agents, interactivity components for user interface, custom objects, or combinations thereof.

19. The multi-region business process infrastructure system of claim 15, wherein the system is further configured to detect a new version of the business process infrastructure code and automatically update the one or more business process infrastructure modules in each deployed region and/or organization.

20. The multi-region business process infrastructure system of claim 15, wherein the platform is configured to:
publish the one or more business process infrastructure modules for distribution over the platform;
create a blueprint of each of the one or more business process infrastructure modules, wherein each blueprint comprises information to deploy the respective business process infrastructure code for another region and/or organization;
store each blueprint in a blueprint repository.

21. The multi-region business process infrastructure system of claim 20, wherein the platform is further configured to:
receive an instantiation request from a user from the another region and/or organization;
transmit one or more blueprints for one or more business process infrastructure modules to the another region and/or organization; and
deploy the business process infrastructure code in the another region and/or organization.

22. A method for implementing a business process for a plurality of regions for a client, the method comprising:
receiving a YAML file and a business process infrastructure code having computer-readable instructions from a user to package a business process infrastructure container to perform a desired operation for a region and/or an organization;
deploying the business process infrastructure code to create one or more business process infrastructure modules for the business process infrastructure container to perform the desired operation for the region and/or an organization; and
distributing of the one or more business process infrastructure modules to a plurality of regions and/or organization;
deploying the one or more business process infrastructure modules in the plurality of regions and/or organizations; and
automatically updating the one or more business process infrastructure modules in the plurality of regions and/or organizations upon update in the business infrastructure code deployed in a region.

23. The method of claim 22, further comprising:
publishing the one or more business process infrastructure modules for distribution over the platform;
creating a blueprint of each of the one or more business process infrastructure modules;
storing each blueprint in a blueprint repository;
transmitting blueprints for one or more business process infrastructure modules to the another region and/or organization; and
deploying the business process infrastructure code in the another region and/or organization.

24. The method of claim 23, further comprising:
receiving an updated version of the one or more business process infrastructure modules from a user;
creating updated blueprint of each of the one or more business process infrastructure modules;
storing the updated blueprint in the blueprint repository
transmitting the updated blueprints to the another region and/or organization; and
deploying the updated business process infrastructure code in the another region and/or organization.
